(19) United States
(12) Patent Application Publication
(10) Pub. No.: US 2015/0252772 A1
(43) Pub. Date: Sep. 10, 2015

(54) CONTROL DEVICE FOR INTERNAL COMBUSTION ENGINE

(71) Applicant: MAZDA MOTOR CORPORATION, Hiroshima (JP)

(72) Inventors: Takafumi Nishio, Otake-shi (JP); Makoto Yuasa, Higashihiroshima-shi (JP); Kenichi Takekoshi, Hiroshima-shi (JP)

(73) Assignee: MAZDA MOTOR CORPORATION, Hiroshima (JP)

(21) Appl. No.: 14/430,885

(22) PCT Filed: Feb. 19, 2014
(86) PCT No.: PCT/JP2014/000854

§ 371 Date: Mar. 24, 2015

(30) Foreign Application Priority Data
Mar. 29, 2013 (JP) 2013-071512

(51) Int. Cl. F02P 5/04; F02D 37/02

(52) U.S. Cl. CPC F02P 5/045; F02D 37/02

(57) ABSTRACT

In order to suppress engine stall and rotation fluctuation after an engine is started in an internal combustion engine capable of using an alcohol-containing fuel, a PCM (50) performs a correction operation of increasing a fuel injection quantity from an initial fuel injection quantity after the engine is started to a fuel injection quantity set when an alcohol concentration of a fuel is regarded as a maximum value or a value close to the maximum value within a predetermined range when a variation of an engine speed is greater than or equal to a threshold during an idle operation after the engine is started, and performs a correction operation of decreasing the increased fuel injection quantity until the variation of the engine speed becomes less than the threshold when the variation is greater than or equal to the threshold after the fuel injection quantity is corrected to increase.

### TECHNICAL FIELD

The present invention relates to a control device for an internal combustion engine, and more particularly, to a control device for an internal combustion engine capable of using a fuel including alcohol.

### BACKGROUND ART

There has been known a flexible fuel vehicle (also referred to as an FFV) equipped with an engine capable of using a fuel containing alcohol such as ethanol for reducing petroleum consumption. Alcohol contains oxygen in a molecule, and thus has a small air volume for realizing a theoretical air-fuel ratio when compared to gasoline. For this reason, an alcohol-containing fuel has a value of a theoretical air-fuel ratio smaller than that of gasoline (that is, on a rich side). For example, as illustrated in FIG. 7, while a gasoline-only fuel has a theoretical air-fuel ratio of 14.7, an ethanol-only fuel has a theoretical air-fuel ratio of 9.0. The theoretical air-fuel ratio of the alcohol-containing fuel varies with an alcohol concentration. For this reason, in the FFV, the alcohol concentration of the alcohol-containing fuel is detected using an alcohol concentration sensor disclosed in Patent Literature 1 such that the FFV may be operated at the theoretical air-fuel ratio irrespective of the alcohol concentration of the alcohol-containing fuel.

For example, a value of a theoretical air-fuel ratio corresponding to a case in which an alcohol-containing fuel referred to as E95 (95% ethanol+5% water) is used is smaller than that corresponding to a case in which an alcohol-containing fuel referred to as E22 (22% ethanol+78% gasoline) is used. An alcohol concentration of a fuel in a fuel tank may have various values according to circumstances since an arbitrary quantity of E95 or E22 is poured into the fuel tank each time fueling is performed. Therefore, it is important to detect a property of a fuel currently in use and inject the fuel at a quantity and a time suitable for the fuel property such that an engine may be continuously operated at a theoretical air-fuel ratio and an exhaust gas may be satisfactorily purified using a three-way catalyst even when the alcohol concentration of the fuel in the fuel tank changes.

### CITATION LIST

### Patent Literature

Patent Literature 1: Japanese Unexamined Patent Publication No. H5-60003 (Paragraph [0008])

### SUMMARY OF INVENTION

However, the alcohol concentration sensor entails increases in hardware complexity and cost. In this regard, it is proposed to learn the alcohol concentration of the alcohol-containing fuel using an oxygen concentration sensor (in particular, a linear air-fuel ratio sensor) provided on an exhaust passage to control feedback of an air-fuel ratio instead of the alcohol-containing fuel.

In other words, since an alcohol concentration of a fuel may be obtained from an oxygen concentration in exhaust gas which is exhausted from a combustion chamber, it is possible to learn the alcohol concentration of the fuel based on the oxygen concentration in the exhaust gas which is detected by the oxygen concentration sensor. As described in the foregoing, as the alcohol concentration increases, the air volume for realizing the theoretical air-fuel ratio decreases. Thus, for example, when exhaust gas contains oxygen remaining after burning, it is possible to determine that the alcohol concentration of the fuel is higher than expected, and learn the alcohol concentration of the fuel based on the oxygen concentration in exhaust gas.

Here, the oxygen concentration sensor is not activated unless an exhaust gas temperature thereof is increased up to a predetermined temperature (for example, several hundred degrees Celsius). For this reason, when an operation in which an engine is suspended is continued while the oxygen concentration sensor is not activated, the alcohol concentration may not be learned for a long period of time even when fueling is performed in the meantime and the alcohol concentration of the fuel in the fuel tank changes. In this case, until the alcohol concentration is learned, a value, as a value of the alcohol concentration, obtained by when the alcohol concentration is finally learned (that is, a learning value which is too old to be used as data) is used as an estimated value of the alcohol concentration.

Meanwhile, when a battery is removed from the FFV, data of the learning value of the alcohol concentration stored in a memory may disappear. In this case, until the alcohol concentration is learned, a default value, as a value of the alcohol concentration, previously registered in a program may be used as an estimated value of the alcohol concentration.

In either case, the estimated value of the alcohol concentration is incorrect, and it is likely that there is a gap between the estimated value and an actual alcohol concentration. For this reason, an air-fuel ratio of an air-fuel mixture is leaner (a larger value) than the theoretical air-fuel ratio when the estimated value of the alcohol concentration is smaller than the actual alcohol concentration, and is richer (a smaller value) than the theoretical air-fuel ratio when the estimated value is greater than the actual alcohol concentration. In addition, for example, when an air conditioner is turned ON and OFF or a system referred to as an accelerated warm-up system (AWS) for an early activation of a catalytic device provided on an exhaust passage is operated during an idle operation (that is, during a period until an accelerator is stepped on and a vehicle starts moving) until the oxygen concentration sensor is activated (that is, until the alcohol concentration can be learned) after the engine is started, changes of fuel injection timing and ignition timing are entailed in various manners, which results in various changes of a combustion type. The changes of the combustion type lead to engine rotation fluctuation and engine stall.

The present invention has been conceived in view of the present state of the internal combustion engine capable of using the alcohol-containing fuel, and an object of the present invention is to provide a control device for the internal combustion engine capable of suppressing occurrences of engine stall and rotation fluctuation after the engine is started even when there is a gap between the estimated value of the alcohol concentration and the actual alcohol concentration.

To solve the problem, the present invention provides a control device for an internal combustion engine capable of using an alcohol-containing fuel, the control device including post-starting injection quantity increasing apparatus for performing a correction operation of increasing a fuel injection quantity from an initial fuel injection quantity after an engine is started to a fuel injection quantity set when an alcohol concentration of a fuel is regarded as a maximum value or a value close to the maximum value within a predetermined range, when a variation of an engine speed is greater than or equal to a predetermined threshold during an idle operation until an oxygen concentration sensor provided to an exhaust passage is activated after the engine is started, and post-starting injection quantity decreasing apparatus for performing a correction operation of repeatedly decreasing the increased fuel injection quantity by a smaller correction width than when performing the correction operation of increasing the fuel injection quantity until the variation of the engine speed becomes less than the threshold when the variation is greater than or equal to the threshold after the correction operation of increasing the fuel injection quantity by the post-starting injection quantity increasing apparatus.

In addition, the present invention provides a control device for an internal combustion engine capable of using an alcohol-containing fuel, the control device including start-up injection quantity increasing apparatus for performing, when an engine is started, a correction operation of increasing a fuel injection quantity up to a fuel injection quantity set when an alcohol concentration of a fuel is regarded as a maximum value or a value close to the maximum value within a predetermined range when an engine is not started by a predetermined number of times of ignitions, and post-starting injection quantity decreasing apparatus for performing a correction operation of repeatedly decreasing the increased fuel injection quantity by a predetermined correction width until a variation of an engine speed becomes less than a predetermined threshold when the variation is greater than or equal to the threshold during an idle operation until an oxygen concentration sensor provided to an exhaust passage is activated after the engine is started.

Objects, characteristics and advantages of the present invention of the description and others are obvious from detailed description below and accompanying drawings.

### BRIEF DESCRIPTION OF DRAWINGS

FIG. 1 is a diagram illustrating an overall configuration of an engine serving as an internal combustion engine mounted on a flexible fuel vehicle (FFV) according to an embodiment of the present invention.

FIG. 2 is a diagram illustrating a control system of the engine.

FIG. 3 is a flowchart of a control operation performed by a powertrain control module (PCM) of the engine during an idle operation after the engine is started from a point in time when the engine is started.

FIG. 4 is a diagram illustrating fuel injection timing and ignition timing during the idle operation after the engine is started from the point in time when the engine is started.

FIG. 5 is a flowchart of a modified example of the control operation of FIG. 3.

FIG. 6 is a flowchart of another modified example of the control operation of FIG. 3.

FIG. 7 is a diagram illustrating a relation between an alcohol concentration and a theoretical air-fuel ratio in an alcohol-containing fuel.

### DESCRIPTION OF EMBODIMENTS

Hereinafter, embodiments of the present invention will be described with reference to drawings.

(1) Overall Configuration

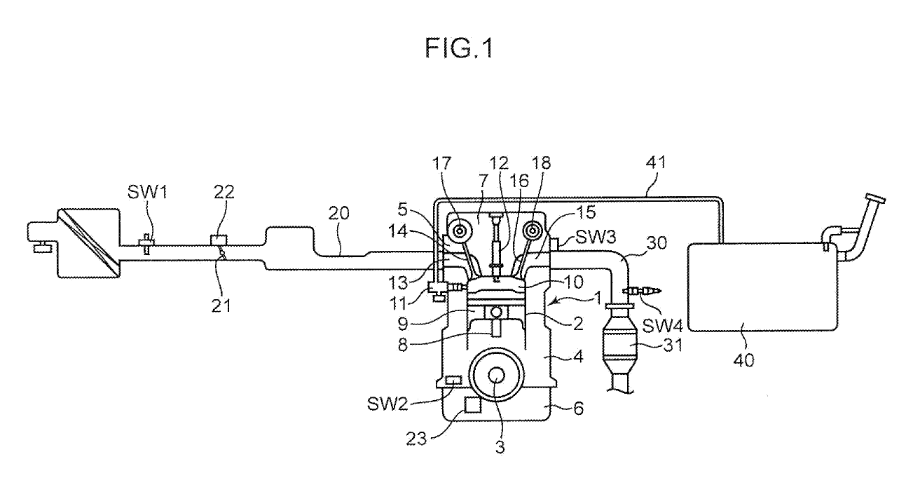

As illustrated in FIG. 1, an engine 1 serving as an internal combustion engine according to the present embodiment is a spark ignition type 4-cycle engine including a plurality of cylinders 2 (only one cylinder is illustrated in FIG. 1). An external shape of a main body of the engine is roughly formed by a cylinder block 4 that rotatably supports a crankshaft 3, a cylinder head 5 disposed above the cylinder block 4, an oil pan 6 disposed below the cylinder block 4, and a head cover 7 disposed above the cylinder head 5.

A piston 9 connected to the crankshaft 3 through a conrod 8 is slidably accommodated in each of the cylinders 2, and a combustion chamber 10 is formed above the piston 9. The cylinder head 5 is provided with an injector (which corresponds to fuel injection apparatus of the present invention) 11 that directly injects a fuel into the combustion chamber 10. In addition, a spark plug 12, an intake valve 14 for opening and closing an intake port 13, and an exhaust valve 16 for opening and closing an exhaust port 15 are provided on a ceiling wall of the combustion chamber 10. The intake valve 14 and the exhaust valve 16 are operated to be opened and closed in linkage with the crankshaft 3 by valve gear mechanisms 17 and 18, each of which has a camshaft and a variable valve timing (VVT) mechanism (not illustrated).

An intake passage 20 is connected to the intake port 13, and an exhaust passage 30 is connected to the exhaust port 15. The intake passage 20 is provided with a throttle valve 21 for adjusting an intake air volume, and the exhaust passage 30 is provided with a catalytic device 31 that accommodates a three-way catalyst (not illustrated) for purifying exhaust gas.

In addition, a starter motor 23 is provided to perform cranking by being driven when the engine 1 is started.

The engine 1 according to the present embodiment is an engine capable of using an ethanol-containing fuel. In other words, a vehicle according to the present embodiment is a flexible fuel vehicle (FFV). For this reason, a fuel tank 40 is fueled with an ethanol-containing fuel, for example, E95 (fuel of 95% ethanol+5% water), E22 (fuel of 22% ethanol+78% gasoline), or the like. An arbitrary quantity of E95 or E22 is poured into the fuel tank 40 during fueling, and thus an ethanol concentration of the fuel in the fuel tank 40 may have various values according to circumstances. In addition, the ethanol-containing fuel in the fuel tank 40 is supplied to the injector 11 through a fuel feeding pipe 41, and is directly injected into the combustion chamber 10 from the injector 11.

In the engine 1 according to the present embodiment, the fuel is directly injected into the combustion chamber 10, and thus the fuel supplied to the injector 11 has a pressure set to a relatively high value. For this reason, atomization of the fuel injected from the injector 11 is accelerated.

In the engine 1 according to the present embodiment, a geometric compression ratio and an effective compression ratio are set to relatively high values. For this reason, for example, when the fuel is directly injected into the combustion chamber 10 in a second half of a compression stroke when the engine 1 is started, vaporization of the injected fuel is accelerated in the high-temperature combustion chamber 10 to generate a rich air-fuel mixture around the spark plug 12 (weak lamination), and enhancement of ignitable stability is attempted together with atomization of the fuel.

Incidentally, while gasoline corresponds to a mixture of a plurality of components having different molecular formulas, alcohol corresponds to a single component defined by one molecular formula. For this reason, while gasoline may evaporate and vaporize to ignite and combust even at a low temperature due to the presence of a low-boiling point component, alcohol does not evaporate and vaporize at a temperature below a boiling point (78.3° C. for ethanol) and thus does not ignite and combust. Therefore, it is difficult to start the engine.

To deal with the problem, heretofore, a sub-tank, a feeding pipe, a fuel rail, and a sub-injector only for E22 or gasoline having a low alcohol concentration have been provided only for starting the engine, and the engine has been started using the sub-fuel system only for starting the engine. However, when the sub-fuel system is provided in addition to a main fuel system (the fuel tank 40, the fuel feeding pipe 41, the injector 11, and the like), increases in hardware complexity, cost, and weight of a vehicle are entailed. In addition, a problem to be solved such as an installing position of the sub-tank occurs in terms of safety.

In this regard, in the engine 1 according to the present embodiment, the quantity of evaporation and vaporization is increased in the combustion chamber 10 to ensure startability of the engine 1 even for a blended fuel having a high alcohol concentration by increasing a compression ratio to increase a temperature of the combustion chamber 10 when the piston 9 is increased and injecting the fuel into the combustion chamber 10 in a second half of a compression stroke in addition to attempting atomization of droplets of the fuel injected into the combustion chamber 10 from the injector 11 as described above, instead of providing the sub-fuel system only for starting the engine (sub-tankless system).

(2) Control System

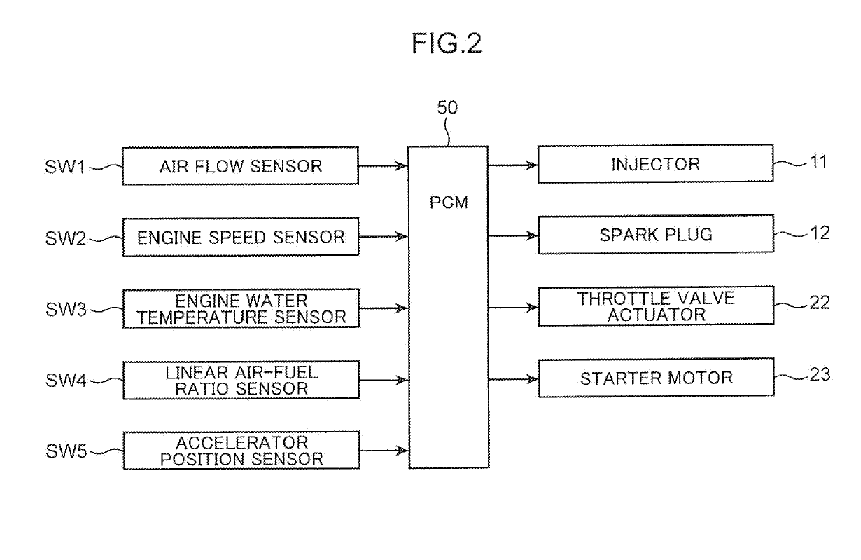

As illustrated in FIG. 2, the engine 1 according to the present embodiment includes a powertrain control module (PCM) 50. The PCM 50 is a microprocessor including a central processing unit (CPU), a read only memory (ROM), a random access memory (RAM), and the like as is generally known, and corresponds to post-starting injection quantity increasing apparatus, post-starting injection quantity decreasing apparatus, injection timing setting apparatus, ignition timing setting apparatus, and start-up injection quantity increasing apparatus of the present invention.

The PCM 50 is interactively and electrically connected to an air flow sensor SW1 provided to the intake passage 20 to detect an intake air volume, an engine speed sensor SW2 for detecting an engine speed, an engine water temperature sensor SW3 for detecting an engine water temperature, a linear air-fuel ratio sensor (corresponding to an oxygen concentration sensor of the present invention) SW4 provided to the exhaust passage 30 to detect an oxygen concentration in exhaust gas, and an accelerator position sensor SW5 for detecting whether a driver operates an accelerator (steps on the accelerator) and an accelerator operation quantity (a quantity at which the accelerator is stepped on).

In addition to performing control operations of starting and normally operating the engine 1 based on various types of information input from the various sensors SW1 to SW 5, the PCM 50 particularly controls feedback of an air-fuel ratio using the linear air-fuel ratio sensor SW4 to operate the engine 1 at the theoretical air-fuel ratio in order to enhance a purification rate of exhaust gas of the catalytic device 31. Further, the PCM 50 performs an ethanol concentration learning control operation of learning the ethanol concentration of the fuel in the fuel tank 40 using, for example, the linear air-fuel ratio sensor SW4 without using the alcohol concentration sensor.

In order to execute the various control operations, the PCM 50 is mutually and electrically connected to the injector 11, the spark plug 12, a throttle valve actuator 22 for driving the throttle valve 21, and the starter motor 23 to output control signals to the various apparatuses.

(3) Control Operation

[3-1] Ethanol Concentration Learning Control

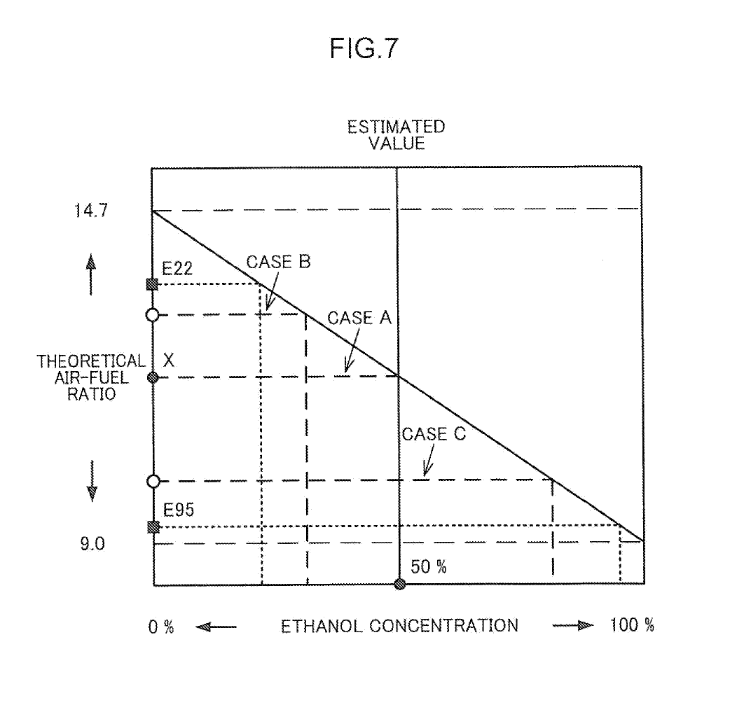

An ethanol concentration learning control operation performed by the PCM 50 is roughly as described below. In other words, a relation between a theoretical air-fuel ratio and an ethanol concentration of a fuel is unambiguously determined. As illustrated in FIG. 7, for example, the theoretical air-fuel ratio is 14.7 when the ethanol concentration is 0% (100% gasoline), and the theoretical air-fuel ratio is 9.0 when the ethanol concentration is 100%. In addition, the theoretical air-fuel ratio of the fuel having the ethanol concentration that corresponds to a value between 0% and 100% (more than 0% and less than 100%) is on a straight line connecting 14.7 and 9.0 on a one-to-one basis. The straight line has a slope at which the theoretical air-fuel ratio decreases by 0.057 each time the ethanol concentration increases by 1%.

For example, it is presumed that a fuel injection quantity realized by a theoretical air-fuel ratio X is set by estimating a current ethanol concentration at 50%. As a result, when a theoretical air-fuel ratio specified based on information from the linear air-fuel ratio sensor SW4 is X, it is possible to determine that the estimated value is correct (an actual ethanol concentration is 50%) (Case A). However, when the theoretical air-fuel ratio specified based on information from the linear air-fuel ratio sensor SW4 is greater than X, it is possible to determine that the actual ethanol concentration is less than 50% by the difference (Case B). In addition, when the theoretical air-fuel ratio specified based on information from the linear air-fuel ratio sensor SW4 is less than X, it is possible to determine that the actual ethanol concentration is greater than 50% by the difference (Case C).

The PCM 50 obtains a deviation of an ethanol concentration by applying a deviation of a theoretical air-fuel ratio to the slope of the straight line. In addition, the PCM 50 learns an actual ethanol concentration by adding the deviation of the ethanol concentration to an initially estimated value (50% in the example).

[3-2] Starting Control to Idle Operation Control after Starting

### Control Example 1

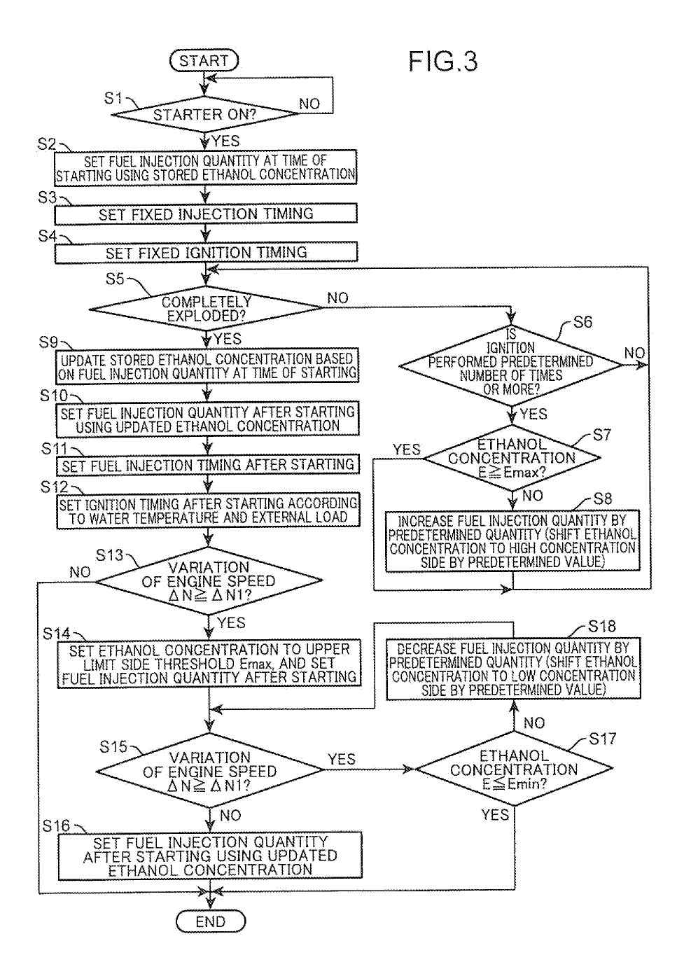

FIG. 3 is a flowchart of a control operation performed by the PCM 50 during an idle operation after the engine is started from a point in time when the engine is started.

As described in the foregoing, since the ethanol concentration of the fuel in the fuel tank 40 may fluctuate due to fueling, the ethanol concentration learning control operation is performed each time fueling is performed, and a learning value is updated. In addition, until subsequent fueling is performed, for example, an operation of controlling feedback of an air-fuel ratio, an operation of controlling starting of the engine 1, an operation of controlling an idle operation, and the like are executed using a latest ethanol concentration obtained by a most recently (that is, finally) executed ethanol concentration learning control operation.

Here, the linear air-fuel ratio sensor SW4 is not activated unless an exhaust gas temperature thereof is increased up to several hundred degrees Celsius. For this reason, when an operation in which an engine 1 is suspended is continued while the linear air-fuel ratio sensor SW4 is not activated, the ethanol concentration may not be learned for a long period of time even when fueling is performed in the meantime and the ethanol concentration of the fuel in the fuel tank 40 changes. In this case, until the ethanol concentration is learned, the PCM 50 uses a value, as a value of the ethanol concentration, obtained by the finally executed ethanol concentration learning control operation (that is, a learning value which is too old to be used as data) as an estimated value of the ethanol concentration.

Meanwhile, when a battery is removed from a vehicle, data of the learning value of the ethanol concentration stored in a memory of the PCM 50 may disappear. In this case, until the ethanol concentration is learned, the PCM 50 uses a default value, as a value of the ethanol concentration, previously registered in a program as an estimated value of the ethanol concentration.

In either case, the estimated value of the ethanol concentration is incorrect, and it is likely that there is a gap between the estimated value and an actual ethanol concentration. For this reason, an air-fuel ratio of an air-fuel mixture is leaner (a larger value) than the theoretical air-fuel ratio when the estimated value of the ethanol concentration is smaller than the actual ethanol concentration, and is richer (a smaller value) than the theoretical air-fuel ratio when the estimated value is greater than the actual ethanol concentration. In addition, for example, when an air conditioner is turned ON and OFF or an AWS for an early activation of the catalytic device 31 is operated during an idle operation (that is, during a period until an accelerator is stepped on and a vehicle starts moving) until the linear air-fuel ratio sensor SW4 is activated (that is, until the ethanol concentration can be learned) after the engine is started, changes of fuel injection timing and ignition timing are entailed in various manners, which results in various changes of a combustion type. Engine stall easily occurs if the combustion type changes when the air-fuel ratio of the air-fuel mixture is leaner than the theoretical air-fuel ratio, and rotation fluctuation of the engine 1 easily occurs if the combustion type changes when the air-fuel ratio of the air-fuel mixture is richer than the theoretical air-fuel ratio. Indeed, this is a result, and rotation of the engine fluctuates since torque generated for each instance of combustion is unstable when the air-fuel ratio of the air-fuel mixture is either leaner or richer than the theoretical air-fuel ratio as a result of incorrectness of the estimated value of the ethanol concentration. However, while rotation of the engine continues fluctuating when the air-fuel ratio is richer than the theoretical air-fuel ratio, the engine stalls after rotation of the engine fluctuates when the air-fuel ratio is leaner than the theoretical air-fuel ratio.

The flowchart illustrated in FIG. 3 is created as a countermeasure to suppress occurrences of engine stall and rotation fluctuation after the engine started even when there is a gap between the estimated value of the ethanol concentration and the actual ethanol concentration.

That is, in step S1, the PCM 50 determines whether the starter motor 23 is turned ON, in other words, whether the engine 1 is started.

When the result is YES, the PCM 50 sets a fuel injection quantity at the time of starting using a stored ethanol concentration in step S2. Here, the stored ethanol concentration typically refers to a latest ethanol concentration obtained by an ethanol concentration learning control operation which is most recently (in other words, lately) executed. However, here, the estimated value of the ethanol concentration (an old learning value when the ethanol concentration is not learned for a long period of time, or a default value when data disappears) is included.

The PCM 50 sets a fuel injection quantity increased from a fuel injection quantity at which the theoretical air-fuel ratio is realized by a predetermined quantity when the engine 1 is started. In other words, an air-fuel ratio slightly richer than the theoretical air-fuel ratio is regarded as a target air-fuel ratio when the engine 1 is started.

Next, the PCM 50 sets fixed injection timing as injection timing in step S3, and sets fixed ignition timing as ignition timing in step S4.

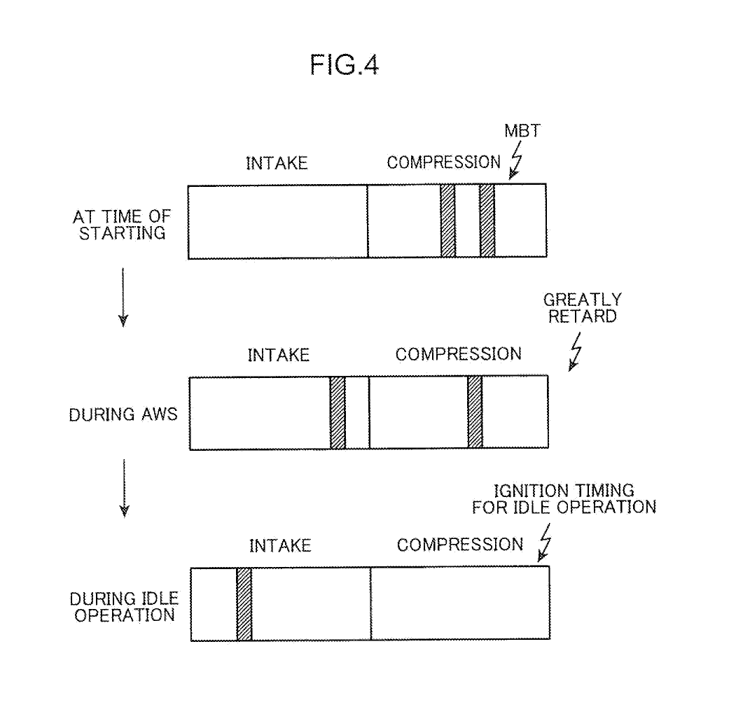

Specifically, as illustrated in FIG. 4, when the engine 1 is started, the PCM 50 sets fuel injection timing (indicated by hatched areas in the figure) to a second half of a compression stroke, and sets ignition timing to a minimum advance for best torque (MBT) immediately before a compression top dead center corresponding to a predetermined fixed value. FIG. 4 illustrates a case in which a fuel is injected at two divided stages. An operation of the PCM 50 in step S3 and an operation in step S11 described below collectively correspond to an operation serving as the injection timing setting apparatus of the present invention. In addition, an operation of the PCM 50 in step S4 and an operation in step S12 described below collectively correspond to an operation serving as the ignition timing setting apparatus of the present invention.

Next, in step S5, the PCM 50 determines whether the engine 1 is completely exploded, in other words, whether an engine speed specified based on information from the engine speed sensor SW2 increases up to a predetermined number of revolutions (the number of revolutions at which it is possible to determine that the engine 1 starts to revolve without an external force). The operation proceeds to step S9 when the result is YES, and proceeds to step S6 when the result is NO.

In step S6, the PCM 50 determines whether ignition is performed a predetermined number of times or more. The operation returns to step S5 when the result is NO, and proceeds to step S7 when the result is YES.

In step S7, the PCM 50 determines whether an ethanol concentration E is greater than or equal to an upper limit side threshold Emax (E≧Emax). The operation returns to step S5 to continue to control starting when the result is YES, and proceeds to step S8 when the result is NO.

In step S8, the PCM 50 increases the fuel injection quantity (which is set in step S2) by a predetermined quantity. In other words, the PCM 50 shifts the ethanol concentration used to set the fuel injection quantity at the time of starting in step S2 to a high concentration side by a predetermined value, and resets the fuel injection quantity at the time of starting using the ethanol concentration shifted to the high concentration side. In this case, the fuel injection quantity, at which the target air-fuel ratio at the time of starting is realized, is increased by a value at which the ethanol concentration is shifted to the high concentration side.

The PCM 50 returns to step S5 from step S8 to repeat the operations of determining whether the engine 1 is completely exploded (corresponding to steps S5 to S8). In other words, the PCM 50 repeatedly shifts the ethanol concentration to the high concentration side until the ethanol concentration E is greater than or equal to the upper limit side threshold Emax in steps S5 to S8. As described in the foregoing, the engine 1 according to the present embodiment employs the sub-tankless system such that the quantity of evaporation and vaporization is increased in the combustion chamber 10 to ensure startability of the engine 1 even for a blended fuel having a high ethanol concentration, and thus the engine 1 is completely exploded when the ethanol concentration E is less than the upper limit side threshold Emax under normal circumstances. Therefore, when the engine 1 is determined not to be completely exploded in step S5 while the ethanol concentration E is determined to be greater than or equal to the upper limit side threshold Emax in step S7, the PCM 50 continues to inject the fuel at an ethanol concentration at the time, and controls, for example, an air intake quantity, ignition timing, and the like other than fuel injection to promote complete explosion although not illustrated in FIG. 3.

In the present embodiment, a maximum value of the ethanol concentration of the fuel is 95% (E95). In other words, the upper limit side threshold Emax used as a determination threshold in step S7 is a value close to the maximum value (95%) within a predetermined range (for example, within a range of 15%). A separate threshold is used without using 95% that corresponds to the maximum value of the ethanol concentration of the fuel as the determination threshold in step S7 since complete explosion is regarded not to occur even at 95% when complete explosion does not occur at the threshold.

When the engine 1 is determined to be completely exploded in step S5, the PCM 50 updates the stored ethanol concentration based on the fuel injection quantity at the time of starting in step S9. In other words, the ethanol concentration used for setting the fuel injection quantity at the time of starting in step S2 is rewritten into the ethanol concentration corresponding to a case in which the engine 1 is determined to be completely exploded in step S5 (ethanol concentration used in step S2 when complete explosion occurs without undergoing steps S7 and S8, and ethanol concentration obtained by being finally shifted to the high concentration side in step S8 when complete explosion occurs through steps S7 and S8).

Next, in step S10, the PCM 50 sets a fuel injection quantity after starting using the updated ethanol concentration. Here, the PCM 50 sets the fuel injection quantity at which the theoretical air-fuel ratio is realized after the engine 1 is started. In other words, the theoretical air-fuel ratio is regarded as a target air-fuel ratio after the engine 1 is started.

Next, the PCM 50 sets fuel injection timing after the starting as injection timing in step S11, and sets ignition timing after the starting according to an external load (for example, turning ON/OFF of an air conditioner) and the engine water temperature specified based on information from the engine water temperature sensor SW3 in step S12.

Specifically, the PCM 50 is switched to an idle operation after the engine 1 is started as illustrated in FIG. 4. However, for example, when the catalytic device 31 is not activated at the time of cold starting, the PCM 50 is switched to a normal idle operation after operating the AWS. During an operation of the AWS, the PCM 50 advances fuel injection timing further than when the engine 1 is started, and sets fuel injection timing to a second half of an intake stroke (first stage) and a second half of a compression stroke (second stage). In addition, during the operation of the AWS, the PCM 50 drastically retards ignition timing beyond a compression top dead center. A retard quantity of ignition timing is variably set according to the engine water temperature and the external load. During the normal idle operation, the PCM 50 advances fuel injection timing further than when the engine 1 is started, and sets fuel injection timing to a first half of the intake stroke (collective injection). In addition, during the normal idle operation, the PCM 50 sets ignition timing to predetermined ignition timing for the idle operation which is prior to the compression top dead center and subsequent to the MBT. The ignition timing for the idle operation is also variably set according to the engine water temperature and the external load.

Next, in step S13, the PCM 50 determines whether a variation ΔN of the engine speed is greater than or equal to a predetermined threshold ΔN1 (ΔN≧ΔN1). This control operation ends when the result is NO, and the operation proceeds to step S14 when the result is YES.

The PCM 50 sets the ethanol concentration updated in step S9 to a high concentration value (upper limit side threshold Emax) in step S14, and resets an initial fuel injection quantity after starting (which is set in step S10) using the ethanol concentration set to the high concentration value. In this case, the fuel injection quantity realized by the target air-fuel ratio after starting (theoretical air-fuel ratio) is increased to be greater than the fuel injection quantity set in step S10 by a value at which the ethanol concentration is set to the high concentration value. This operation of the PCM 50 in step S14 corresponds to an operation as the post-starting injection quantity increasing apparatus of the present invention.

In the present embodiment, the maximum value of the ethanol concentration of the fuel is 95% (E95). In other words, the upper limit side threshold Emax which is set as the high concentration value in step S14 is a value close to the maximum value (95%) within a predetermined range (for example, within a range of 15%). The upper limit side threshold Emax is used without using 95% that corresponds to the maximum value of the ethanol concentration of the fuel as the high concentration value in step S14 since the rotation fluctuation of the engine 1 is regarded not to be suppressed at 95% when the rotation fluctuation is not suppressed at the upper limit side threshold Emax.

Next, in step S15, the PCM 50 determines again whether the variation ΔN of the engine speed is greater than or equal to the predetermined threshold ΔN1 (ΔN≧ΔN1). The operation proceeds to step S16 when the result is NO, and proceeds to step S17 when the result is YES.

In step S16, the PCM 50 sets a fuel injection quantity after subsequent starting using the ethanol concentration updated in step S14 (upper limit side threshold Emax), and this control operation ends.

In step S17, the PCM 50 determines whether the ethanol concentration E is less than or equal to a lower limit side threshold Emin (E≦Emin). This control operation ends when the result is YES, and the operation proceeds to step S18 when the result is NO.

In step S18, the PCM 50 decreases the fuel injection quantity (which is set in step S14) by a predetermined quantity. In other words, the PCM 50 shifts the ethanol concentration (upper limit side threshold Emax) used to set the fuel injection quantity after starting in step S14 to a low concentration side by a predetermined value, and resets the fuel injection quantity after starting using the ethanol concentration shifted to the low concentration side. In this case, the fuel injection quantity, at which the target air-fuel ratio after starting is realized, is decreased by a value at which the ethanol concentration is shifted to the low concentration side. This operation of the PCM 50 in step S18 corresponds to an operation as the post-starting injection quantity decreasing apparatus of the present invention.

The PCM 50 returns to step S15 from step S18 to repeat the operations of determining whether rotation fluctuation of the engine 1 is suppressed (steps S15, S17 and S18). In other words, the PCM 50 repeatedly shifts the ethanol concentration to the low concentration side until the ethanol concentration E becomes less than or equal to the lower limit side threshold Emin in steps S15, S17 and S18. As described in the foregoing, rotation of the engine 1 fluctuates since torque generated for each instance of combustion is unstable when the air-fuel ratio of the air-fuel mixture is either leaner or richer than the theoretical air-fuel ratio as a result of incorrectness of the estimated value of the ethanol concentration. First, even though the fuel injection quantity is increased by shifting the ethanol concentration to the high concentration side in step S14, the rotation fluctuation of the engine 1 is not suppressed (YES in step S15). Thus, next, the fuel injection quantity is decreased by shifting the ethanol concentration to the low concentration side in step S18. Hence, the rotation fluctuation of the engine 1 is normally suppressed when the ethanol concentration E is high beyond the lower limit side threshold Emin. Therefore, when the rotation fluctuation of the engine 1 is determined not to be suppressed in step S15 while the ethanol concentration E is determined to be less than or equal to the lower limit side threshold Emin in step S17, the PCM 50 continues to inject the fuel at an ethanol concentration at the time, and controls, for example, an air intake quantity, ignition timing, and the like other than fuel injection to promote suppression of the rotation fluctuation although not illustrated in FIG. 3.

In the present embodiment, a minimum value of the ethanol concentration of the fuel is 22% (E22). In other words, the lower limit side threshold Emin used as a determination threshold in step S17 is a value close to the minimum value (22%) within a predetermined range (for example, within a range of 15%). The lower limit side threshold Emin is used without using 22% that corresponds to the minimum value of the ethanol concentration of the fuel as the determination threshold in step S17 since the rotation fluctuation of the engine 1 is regarded not to be suppressed at 22% when the rotation fluctuation is not suppressed at the lower limit side threshold Emin.

When the rotation fluctuation of the engine 1 is determined to be suppressed in step S15, the PCM 50 proceeds to S16 to set the fuel injection quantity after subsequent starting using the ethanol concentration updated in step S18, and this control operation ends.

The fuel injection quantity is repeatedly decreased in step S18 as long as YES is determined in step S15 until the ethanol concentration E becomes the lower limit side threshold Emin. On the other hand, the fuel injection quantity is increased once in step S14. For this reason, the PCM 50 performs a correction operation of decreasing the fuel injection quantity of step S18 by a smaller correction width than that at which the fuel injection quantity is increased in step S14.

As described in the foregoing, in Control example 1 illustrated in FIG. 3, the fuel injection quantity is increased once from the initial fuel injection quantity after the engine is started (fuel injection quantity set in step S10) up to the fuel injection quantity which is set when the ethanol concentration is the upper limit side threshold Emax (step S14) when the variation ΔN of the engine speed is greater than or equal to the predetermined threshold ΔN1 (YES in step S13) during the idle operation until the linear air-fuel ratio sensor SW4 provided to the exhaust passage 30 is activated after the engine 1 is started (after step S9). However, when the variation ΔN of the engine speed is greater than or equal to the threshold ΔN1 (YES in step S15), a correction operation of repeatedly decreasing the increased fuel injection quantity (fuel injection quantity set in step S14) by a smaller correction width than that at which the fuel injection quantity is increased (steps S15, S17, and S18) is performed until the variation ΔN becomes less than the threshold ΔN1 (NO in step S15).

### Control Example 2

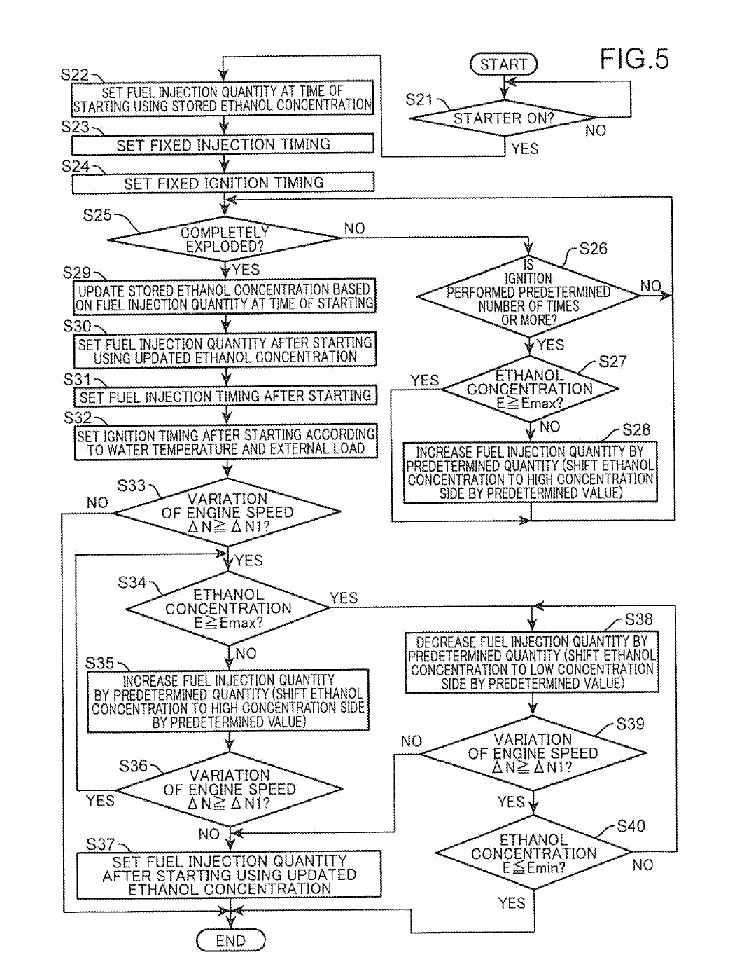

FIG. 5 is a flowchart of a modified example of the control operation of FIG. 3.

Control example 2 illustrated in FIG. 5 is different from Control example 1 in that an operation of increasing of the fuel injection quantity is divided into a plurality of operations to be implemented one at a time in steps S34 to S36 while the fuel injection quantity is increased once in step S14 in Control example 1. Here, only a different part from Control example 1 will be described, and the same part as Control example 1 will not be described. In other words, steps S21 to S32 of FIG. 5 are the same as steps S1 to S12 of FIG. 3, and thus steps S33 to S40 will be described.

In step S33, the PCM 50 determines whether the variation ΔN of the engine speed is greater than or equal to the predetermined threshold ΔN1 (ΔN≧ΔN1). This control operation ends when the result is NO, and proceeds to step S34 when the result is YES.

In step S34, the PCM 50 determines whether the ethanol concentration E is greater than or equal to the upper limit side threshold Emax (E≧Emax). The operation proceeds to step S38 when the result is YES, and proceeds to step S35 when the result is NO.

In step S35, the PCM 50 increases the fuel injection quantity (which is set in step S30) by a predetermined quantity. In other words, in step S30, the PCM 50 shifts the ethanol concentration (which is updated in step S29) used to set the initial fuel injection quantity after starting to the high concentration side by a predetermined concentration, and resets the fuel injection quantity after starting using the ethanol concentration shifted to the high concentration side. In this case, the fuel injection quantity realized by the target air-fuel ratio after starting (theoretical air-fuel ratio) is increased to be greater than the initial fuel injection quantity after starting set in step S30 by a value at which the ethanol concentration is shifted to the high concentration side. This operation of the PCM 50 in step S35 corresponds to an operation as the post-starting injection quantity increasing apparatus of the present invention.

Next, in step S36, the PCM 50 determines again whether the variation ΔN of the engine speed is greater than or equal to the predetermined threshold ΔN1 (ΔN≧ΔN1). The operation proceeds to step S37 when the result is NO, and returns to step S34 when the result is YES.

In step S37, the PCM 50 sets a fuel injection quantity after subsequent starting using the ethanol concentration updated in step S35, and this control operation ends.

The PCM 50 returning to step S34 repeatedly determines whether the rotation fluctuation of the engine 1 is suppressed (steps S34 to S36). In other words, in steps S34 to S36, the PCM 50 repeatedly shifts the ethanol concentration to the high concentration side until the ethanol concentration E becomes greater than or equal to the upper limit side threshold Emax. When the ethanol concentration E is determined to be greater than or equal to the upper limit side threshold Emax (E≧Emax) in step S34, the PCM 50 proceeds to step S38.

In step S38, the PCM 50 decreases the fuel injection quantity (which is set in step S35) by a predetermined quantity. In other words, in step S35, the PCM 50 shifts the ethanol concentration (which is updated in step S35) used to set the fuel injection quantity after starting to the low concentration side by a predetermined concentration, and resets the fuel injection quantity after starting using the ethanol concentration shifted to the low concentration side. In this case, the fuel injection quantity realized by the target air-fuel ratio after starting (theoretical air-fuel ratio) is decreased to be less than the fuel injection quantity after starting set in step S35 by a value at which the ethanol concentration is shifted to the low concentration side. This operation of the PCM 50 in step S38 corresponds to an operation as the post-starting injection quantity decreasing apparatus of the present invention.

Next, in step S39, the PCM 50 determines again whether the variation ΔN of the engine speed is greater than or equal to the predetermined threshold ΔN1 (ΔN≧ΔN1). The operation proceeds to step S37 when the result is NO, and proceeds to step S40 when the result is YES.

In step S37, the PCM 50 sets a fuel injection quantity after subsequent starting using the ethanol concentration updated in step S38, and this control operation ends.

In step S40, the PCM 50 determines whether the ethanol concentration E is less than or equal to the lower limit side threshold Emin (E≦Emin). This control operation ends when the result is YES, and returns to step S38 when the result is NO.

The PCM 50 returning to step S38 repeatedly determines whether the rotation fluctuation of the engine 1 is suppressed (steps S38 to S40). In other words, in steps S38 to S40, the PCM 50 repeatedly shifts the ethanol concentration to the low concentration side until the ethanol concentration E becomes less than or equal to the lower limit side threshold Emin. As described in the foregoing, rotation of the engine 1 fluctuates since torque generated for each instance of combustion is unstable when the air-fuel ratio of the air-fuel mixture is either leaner or richer than the theoretical air-fuel ratio as a result of incorrectness of the estimated value of the ethanol concentration. First, even though the fuel injection quantity is increased by shifting the ethanol concentration to the high concentration side in step S35, the rotation fluctuation of the engine 1 is not suppressed (YES in step S36). Thus, next, the fuel injection quantity is decreased by shifting the ethanol concentration to the low concentration side in step S38. Hence, the rotation fluctuation of the engine 1 is normally suppressed when the ethanol concentration E is high beyond the lower limit side threshold Emin. Therefore, when the rotation fluctuation of the engine 1 is determined not to be suppressed in step S39 while the ethanol concentration E is determined to be less than or equal to the lower limit side threshold Emin in step S40, the PCM 50 continues to inject the fuel at an ethanol concentration at the time, and controls, for example, an air intake quantity, ignition timing, and the like other than fuel injection to promote suppression of the rotation fluctuation although not illustrated in FIG. 5.

As described in the foregoing, in Control example 2 illustrated in FIG. 5, the operation of increasing the fuel injection quantity is divided into a plurality of operations to be implemented one at a time, the increase being implemented from the initial fuel injection quantity after the engine is started (fuel injection quantity set in step S30) up to the fuel injection quantity which is set when the ethanol concentration is the upper limit side threshold Emax (steps S34 to S36) when the variation ΔN of the engine speed is greater than or equal to the predetermined threshold ΔN1 (YES in step S33) during the idle operation until the linear air-fuel ratio sensor SW4 provided to the exhaust passage 30 is activated after the engine 1 is started (after step S29). However, when the variation ΔN of the engine speed is greater than or equal to the threshold ΔN1 (YES in step S36), the increased fuel injection quantity (fuel injection quantity set in step S35) is repeatedly decreased (steps S38 to S40) until the variation ΔN becomes less than the threshold ΔN1 (NO in step S39).

### Control Example 3

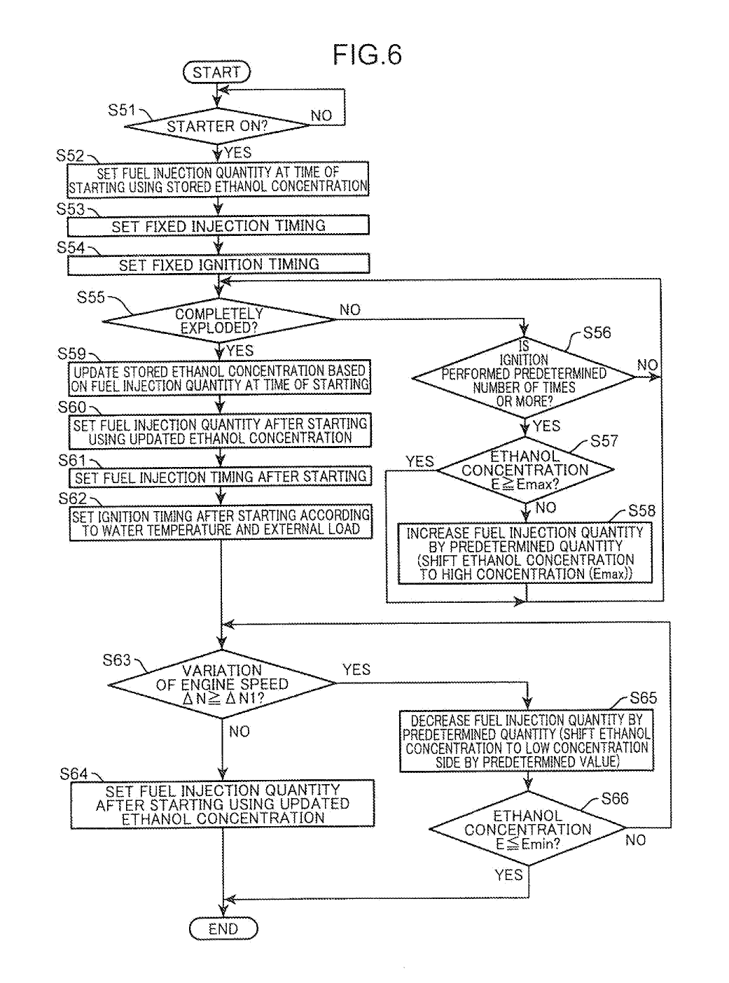

FIG. 6 is a flowchart of another modified example of the control operation of FIG. 3.

Control example 3 illustrated in FIG. 6 is different from Control example 1 in that the fuel injection quantity is increased when the engine 1 is started in step S58 while the fuel injection quantity is increased after the engine 1 is started in step S14 in Control example 1. Here, only a different part from Control example 1 will be described, and the same part as Control example 1 will not be described. In other words, steps S51 to S57 and S59 to S62 of FIG. 6 are the same as steps S1 to S7 and S9 to S12 of FIG. 3, and thus steps S58 and S63 to S66 will be described.

In step S58, the PCM 50 increases the fuel injection quantity (which is set in step S52) by a predetermined quantity. In other words, the PCM 50 shifts the ethanol concentration used to set the fuel injection quantity at the time of starting to the upper limit side threshold Emax in step S52, and resets the fuel injection quantity at the time of starting using the ethanol concentration of the upper limit side threshold Emax. In this case, the fuel injection quantity realized by the target air-fuel ratio at the time of starting is increased by a value at which the ethanol concentration is shifted to the upper limit side threshold Emax. This operation of the PCM 50 in step S58 corresponds to an operation as the start-up injection quantity increasing apparatus of the present invention.

In addition, in step S63, the PCM 50 determines whether the variation ΔN of the engine speed is greater than or equal to the predetermined threshold ΔN1 (ΔN≧ΔN1). The operation proceeds to step S64 when the result is NO, and proceeds to step S65 when the result is YES.

In step S64, the PCM 50 sets a fuel injection quantity after subsequent starting using the ethanol concentration updated in step S59, and this control operation ends.

In step S65, the PCM 50 decreases the fuel injection quantity (which is set in step S60) by a predetermined quantity. In other words, in step S60, the PCM 50 shifts the ethanol concentration (which is updated in step S59) used to set the initial fuel injection quantity after starting to the low concentration side by a predetermined concentration, and resets the fuel injection quantity after starting using the ethanol concentration shifted to the low concentration side. In this case, the fuel injection quantity realized by the target air-fuel ratio after starting (theoretical air-fuel ratio) is decreased to be less than the initial fuel injection quantity after starting set in step S60 by a predetermined correction width corresponding to a predetermined value at which the ethanol concentration is shifted to the low concentration side. This operation of the PCM 50 in step S65 corresponds to an operation as the post-starting injection quantity decreasing apparatus of the present invention.

Next, in step S66, the PCM 50 determines whether the ethanol concentration E is less than or equal to the lower limit side threshold Emin (E≦Emin). This control operation ends when the result is YES, and returns to step S63 when the result is NO.

The PCM 50 returning to step S63 repeatedly determines whether the rotation fluctuation of the engine 1 is suppressed (steps S63, S65 and S66). In other words, the PCM 50 repeatedly shifts the ethanol concentration to the low concentration side until the ethanol concentration E becomes less than or equal to the lower limit side threshold Emin in steps S63, S65 and S66. As described in the foregoing, rotation of the engine 1 fluctuates since torque generated for each instance of combustion is unstable when the air-fuel ratio of the air-fuel mixture is either leaner or richer than the theoretical air-fuel ratio as a result of incorrectness of the estimated value of the ethanol concentration. First, even though the fuel injection quantity is increased by shifting the ethanol concentration up to the upper limit side threshold Emax when the engine 1 is started in step S58, the rotation fluctuation of the engine 1 is not suppressed (YES in step S63). Thus, next, the fuel injection quantity is decreased by shifting the ethanol concentration to the low concentration side after the engine 1 is started in step S65. Hence, the rotation fluctuation of the engine 1 is normally suppressed when the ethanol concentration E is high beyond the lower limit side threshold Emin. Therefore, when the rotation fluctuation of the engine 1 is determined not to be suppressed in step S63 while the ethanol concentration E is determined to be less than or equal to the lower limit side threshold Emin in step S66, the PCM 50 continues to inject the fuel at an ethanol concentration at the time, and controls, for example, an air intake quantity, ignition timing, and the like other than fuel injection to promote suppression of the rotation fluctuation although not illustrated in FIG. 6.

As described in the foregoing, in Control example 3 illustrated in FIG. 6, the fuel injection quantity is increased up to the fuel injection quantity which is set when the ethanol concentration is the upper limit side threshold Emax (step S58) when the engine 1 is not started (YES in step S56) by a predetermined number times or more of ignitions with the fuel injection quantity set in step S52 (fuel injection quantity at the time of starting which is set using the stored ethanol concentration) when the engine 1 is started (steps S51 to S58). In addition, when the variation ΔN of the engine speed is greater than or equal to the predetermined threshold ΔN1 (YES in step S63) during the idle operation until the linear air-fuel ratio sensor SW4 provided to the exhaust passage 30 is activated after the engine 1 is started (after step S59), a correction operation of decreasing the increased fuel injection quantity (fuel injection quantity which is set in step S58) by a predetermined correction width is repeatedly performed (steps S63, S65 and S66) until the variation ΔN becomes less than the threshold ΔN1 (NO in step S63).

(4) Effect

As described in the foregoing, the present embodiment employs characteristic configurations as below in a control device of the engine 1 as the internal combustion engine capable of using the ethanol-containing fuel.

In other words, when the variation ΔN of the engine speed is greater than or equal to the predetermined threshold ΔN1 (YES in steps S13 and S33) during the idle operation until the linear air-fuel ratio sensor SW4 is activated after the engine 1 is started (after steps S9 and S29), the PCM 50 increases the fuel injection quantity from the initial fuel injection quantity after the engine is started (fuel injection quantity which is set in steps S10 and S30) to the fuel injection quantity which is set when, for example, the ethanol concentration of the fuel is regarded as the upper limit side threshold Emax (steps S14 and S34 to S36). Thereafter, when the variation ΔN of the engine speed is greater than or equal to the threshold ΔN1 (YES in steps S15 and S36), the PCM 50 repeatedly decreases the increased fuel injection quantity (fuel injection quantity which is set in steps S14 and S35) (steps S15, S17, S18, and S38 to S40) until the variation ΔN becomes less than the threshold ΔN1 (NO in steps S15 and S39).

According to this configuration, in order to avoid engine stall which is greatly disadvantageous to the FFV in that when engine stall occurs in the FFV the combustion chamber 10 is cooled to cause difficulty in starting the engine 1 since ethanol has great latent heat of vaporization, first, the fuel injection quantity is corrected to be increased. Thus, when the air-fuel ratio is leaner than the theoretical air-fuel ratio, rotation fluctuation of the engine 1 is suppressed by the air-fuel ratio approaching the theoretical air-fuel ratio while avoiding engine stall that causes difficulty in starting the engine 1. On the other hand, even when the air-fuel ratio is richer than the theoretical air-fuel ratio, it is possible to avoid engine stall which is greatly disadvantageous. In addition, when the engine rotation still greatly fluctuates after the fuel injection quantity is corrected to be increased, the fuel injection quantity is corrected to be decreased. Thus, rotation fluctuation of the engine 1 is suppressed by the air-fuel ratio approaching the theoretical air-fuel ratio when the air-fuel ratio is richer than the theoretical air-fuel ratio. In other words, engine stall, which is peculiarly disadvantageous to the FFV in that starting of the engine 1 is difficult, is preferentially avoided, and rotation fluctuation of the engine 1 is additionally suppressed.

As described above, according to the present embodiment, with regard to the engine 1 capable of using the ethanol-containing fuel, it is possible to provide the control device of the engine 1 capable of suppressing occurrences of engine stall and rotation fluctuation after the engine 1 is started even when there is a gap between the estimated value of the ethanol concentration and the actual ethanol concentration.

Further, in the present embodiment, when the fuel injection quantity is corrected to be increased, the PCM 50 increases the fuel injection quantity up to the fuel injection quantity which is set when, for example, the alcohol concentration of the fuel is regarded as the upper limit side threshold Emax, and thus the fuel injection quantity is increased as much as possible, thereby reliably avoiding occurrence of engine stall.

Furthermore, in the present embodiment, when the fuel injection quantity is corrected to be decreased, the PCM 50 performs a correction operation of repeatedly decreasing the fuel injection quantity by a smaller correction width than that at which the fuel injection quantity is increased, and thus the fuel injection quantity is decreased stage by stage. For this reason, it is possible to suppress a defect such as occurrence of engine stall caused by the fuel injection quantity that is greatly decreased at one time such that the air-fuel ratio becomes lean.

In the present embodiment, the PCM 50 performs a correction operation of increasing the fuel injection quantity at one operation (step S14 of Control example 1).

According to this configuration, when the fuel injection quantity is corrected to be increased, the fuel injection quantity is increased as much as possible at one time. Thus, occurrence of engine stall is more reliably avoided.

In the present embodiment, the PCM 50 divides a correction operation of increasing the fuel injection quantity into a plurality of operations to be implemented one at a time (steps S34 to S36 of Control example 2).

According to this configuration, when the fuel injection quantity is corrected to be increased, the fuel injection quantity is increased stage by stage. Therefore, when the air-fuel ratio is leaner than the theoretical air-fuel ratio, the air-fuel ratio is prevented from becoming rich beyond the theoretical air-fuel ratio, and the correction operation of increasing the fuel injection quantity may be suspended at a stage in which the air-fuel ratio approaches the theoretical air-fuel ratio. In addition, even when the air-fuel ratio increases beyond the theoretical air-fuel ratio, the air-fuel ratio does not become excessively rich. Thus, when a correction of decreasing the fuel injection quantity is performed (steps S38 to S40), rotation fluctuation of the engine 1 is suppressed in a short time.

In the present embodiment, as illustrated in FIG. 4, the PCM 50 sets fuel injection timing by the injector 11 that injects the fuel into the combustion chamber 10 to the second half of the compression stroke (steps S3, S23, and S53) when the engine 1 is started, and, after the engine 1 is started, advances the fuel injection timing further than when the engine 1 is started (steps S11, S31, and S61). In addition, as also illustrated in FIG. 4, the PCM 50 sets ignition timing to the MBT which is a predetermined fixed value when the engine 1 is started (steps S4, S24, and S54), and variably controls the ignition timing according to the engine water temperature and the external load (steps S12, S32, and S62) after the engine 1 is started.

According to this configuration, when the engine 1 is started, vaporization of the fuel is accelerated since the fuel is injected in the second half of the compression stroke in which a cylinder temperature increases, and high torque is obtained to promptly increase the engine speed since ignition occurs at the MBT. In addition, after the engine 1 is started, the fuel is injected at timing prior to the second half of the compression stroke, and ignition timing is variably controlled according to the engine water temperature and the external load. In this way, even when operations of controlling fuel injection timing and ignition timing are greatly different between timing at which the engine 1 is started and timing after the engine 1 is started, occurrences of engine stall and rotation fluctuation after the engine 1 is started are suppressed.

In addition, when the engine 1 is not started by a predetermined number of times or more of ignitions (YES in step S56) at the time of starting the engine 1 (steps S51 to S58), more specifically, when the engine 1 is not started by a predetermined number of times or more of ignitions (YES in step S56) with the fuel injection quantity set in step S52, that is, the fuel injection quantity at the time of starting which is set using a latest ethanol concentration obtained by a normally and most recently (that is, finally) executed ethanol concentration learning control operation or an estimated value of the ethanol concentration such as an old learning value when the ethanol concentration is not learned for a long period of time, or a default value when data disappears, the PCM 50 performs a correction operation of increasing the fuel injection quantity up to the fuel injection quantity which is set when, for example, the ethanol concentration of the fuel is regarded as the upper limit side threshold Emax (step S58). In addition, when the variation ΔN of the engine speed is greater than or equal to the predetermined threshold ΔN1 (YES in step S63) during the idle operation until the linear air-fuel ratio sensor SW4 is activated after the engine 1 is started (after step S59), the PCM 50 performs a correction operation of repeatedly decreasing the increased fuel injection quantity (fuel injection quantity which is set in step S58) by a predetermined correction width (steps S63, S65, and S66) until the variation ΔN becomes less than the predetermined threshold ΔN1 (NO in step S63).

In addition to the effect, this configuration is effective in that the engine 1 is reliably started, a time for starting the engine 1 is shortened, rotation fluctuation of the engine is suppressed in a short time after the engine 1 is started, and the like.

Although the ethanol-containing fuel is used as the alcohol-containing fuel in the present embodiment, the present invention is not limited thereto. For example, a methanol-containing fuel, a butanol-containing fuel, or a propanol-containing fuel may be used.

The present invention described above is summarized below.

The present invention relates to a control device for an internal combustion engine capable of using an alcohol-containing fuel, including: post-starting injection quantity increasing apparatus for performing a correction operation of increasing a fuel injection quantity from an initial fuel injection quantity after an engine is started to a fuel injection quantity set when an alcohol concentration of a fuel is regarded as a maximum value or a value close to the maximum value within a predetermined range, when a variation of an engine speed is greater than or equal to a predetermined threshold during an idle operation until an oxygen concentration sensor provided to an exhaust passage is activated after the engine is started; and post-starting injection quantity decreasing apparatus for performing a correction operation of repeatedly decreasing the increased fuel injection quantity by a smaller correction width than when performing the correction operation of increasing the fuel injection quantity until the variation of the engine speed becomes less than the threshold when the variation is greater than or equal to the threshold after the correction operation of increasing the fuel injection quantity by the post-starting injection quantity increasing apparatus.

According to the present invention, in the internal combustion engine capable of using the alcohol-containing fuel, the fuel injection quantity is initially corrected to be increased when the variation of the engine speed is greater than or equal to the threshold during the idle operation until the alcohol concentration can be learned after the engine is started, and the fuel injection quantity is corrected to the decreased when the variation of the engine speed is still greater than or equal to the threshold.

Rotation of the engine greatly fluctuates since torque generated for each instance of combustion is unstable when an air-fuel ratio of an air-fuel mixture is either leaner or richer than a theoretical air-fuel ratio as a result of incorrectness of an estimated value of the alcohol concentration. However, while rotation fluctuation continues when the air-fuel ratio is richer than the theoretical air-fuel ratio, engine stall occurs after rotation fluctuation when the air-fuel ratio is leaner than the theoretical air-fuel ratio. In order to suppress fluctuation of engine rotation, the air-fuel ratio leaner than the theoretical air-fuel ratio may be corrected to be richer by increasing the fuel injection quantity, or the air-fuel ratio richer than the theoretical air-fuel ratio may be corrected to be leaner by decreasing the fuel injection quantity. However, the oxygen concentration sensor is not currently activated, and the alcohol concentration may not be learned. Thus, it is impossible to detect whether the air-fuel ratio is leaner or richer than the theoretical air-fuel ratio. If the fuel injection quantity is corrected to be decreased when the air-fuel ratio is leaner than the theoretical air-fuel ratio, engine stall occurs due to an insufficient fuel. When engine stall occurs in an FFV, it is peculiarly disadvantageous in that a combustion chamber is cooled to cause difficulty in starting the engine since alcohol has great latent heat of vaporization (for example, latent heat of vaporization of ethanol is 0.86 MJ/kg while latent heat of vaporization of gasoline is 0.32 MJ/kg).

In this regard, in the present invention, first, the fuel injection quantity is corrected to be increased in order to avoid engine stall which is greatly disadvantageous to the FFV. If the fuel injection quantity is corrected to be increased, when the air-fuel ratio is leaner than the theoretical air-fuel ratio, rotation fluctuation of the engine is suppressed by the air-fuel ratio approaching the theoretical air-fuel ratio while engine stall that causes difficulty in starting the engine is avoided. On the other hand, even when the air-fuel ratio is richer than the theoretical air-fuel ratio, it is possible to avoid engine stall which is greatly disadvantageous. In addition, when engine rotation still greatly fluctuates after the fuel injection quantity is corrected to be increased, the fuel injection quantity is corrected to be decreased. Thus, the air-fuel ratio approaches the theoretical air-fuel ratio when the air-fuel ratio is richer than the theoretical air-fuel ratio, thereby suppressing rotation fluctuation of the engine. In other words, the present invention preferentially avoids engine stall, which is peculiarly disadvantageous to the FFV in that starting of the engine is difficult, and additionally suppresses rotation fluctuation of the engine.

As described in the foregoing, in the internal combustion engine capable of using the alcohol-containing fuel, the present invention provides a control device for the internal combustion engine capable of suppressing occurrences of engine stall and rotation fluctuation after the engine is started even when there is a gap between an estimated value of an alcohol concentration and an actual alcohol concentration.

Further, in the present embodiment, the fuel injection quantity is increased up to a fuel injection quantity which is set when, for example, the alcohol concentration of the fuel is regarded as a maximum value, or a fuel injection quantity which is set when the alcohol concentration is regarded as a value close to the maximum value within a predetermined range, and thus the fuel injection quantity is increased as much as possible, thereby reliably avoiding occurrence of engine stall.

Furthermore, in the present embodiment, the fuel injection quantity is corrected to be repeatedly decreased by a smaller correction width than that at which the fuel injection quantity is increased, and thus the fuel injection quantity is decreased stage by stage. This suppresses a defect such as occurrence of engine stall caused by the fuel injection quantity that is greatly decreased at one time such that the air-fuel ratio becomes lean.

In the present embodiment, the post-starting injection quantity increasing apparatus preferably performs the correction operation of increasing the fuel injection quantity at one operation.

According to this configuration, when the fuel injection quantity is corrected to be increased, the fuel injection quantity is increased as much as possible at one time. Thus, occurrence of engine stall is more reliably avoided.

In the present embodiment, the post-starting injection quantity increasing apparatus preferably divides the correction operation of increasing the fuel injection quantity into a plurality of operations and implements the operations one at a time.

According to this configuration, when the fuel injection quantity is corrected to be increased, the fuel injection quantity is increased stage by stage. Therefore, when the air-fuel ratio is leaner than the theoretical air-fuel ratio, the air-fuel ratio is prevented from becoming rich beyond the theoretical air-fuel ratio, and the correction operation of increasing the fuel injection quantity may be suspended at a stage in which the air-fuel ratio approaches the theoretical air-fuel ratio. In addition, even when the air-fuel ratio increases beyond the theoretical air-fuel ratio, the air-fuel ratio does not become excessively rich. Thus, when an operation of decreasing the fuel injection quantity is performed, rotation fluctuation of the engine is suppressed in a short time.

The present invention preferably includes: fuel injecting apparatus for injecting a fuel into a combustion chamber; injection timing setting apparatus for setting fuel injection timing at which the fuel is injected by the fuel injecting apparatus to a second half of a compression stroke when the engine is started and, after the engine is started, advancing the fuel injection timing further than when the engine is started; and ignition timing setting apparatus for setting ignition timing to a predetermined fixed value when the engine is started and variably controlling the ignition timing according to a water temperature and an external load after the engine is started.

According to this configuration, when the engine is started, vaporization of the fuel is accelerated since the fuel is injected in the second half of the compression stroke in which a cylinder temperature increases, and high torque is obtained to promptly increase the engine speed since ignition occurs at a predetermined fixed value (for example, MBT). In addition, after the engine is started, the fuel is injected at timing prior to the second half of the compression stroke, and ignition timing is variably controlled according to the water temperature and the external load (for example, turning ON/OFF of an air conditioner, etc.). In this way, even when operations of controlling fuel injection timing and ignition timing are greatly different between timing at which the engine is started and timing after the engine is started, occurrences of engine stall and rotation fluctuation after the engine is started are suppressed.

In addition, the present invention relates to a control device for an internal combustion engine capable of using an alcohol-containing fuel, including: start-up injection quantity increasing apparatus for performing, when an engine is started, a correction operation of increasing a fuel injection quantity up to a fuel injection quantity set when, an alcohol concentration of a fuel is regarded as a maximum value or a value close to the maximum value within a predetermined range when an engine is not started by a predetermined number of times of ignitions, and post-starting injection quantity decreasing apparatus for performing a correction operation of repeatedly decreasing the increased fuel injection quantity by a predetermined correction width until a variation of an engine speed becomes less than a predetermined threshold when the variation is greater than or equal to the threshold during an idle operation until an oxygen concentration sensor provided to an exhaust passage is activated after the engine is started.

In the above-described invention, in order to suppress occurrences of engine stall and rotation fluctuation after the engine is started, in particular, in order to preferentially avoid engine stall, which is peculiarly disadvantageous to the FFV in that starting of the engine is difficult, and additionally suppress rotation fluctuation of the engine, first, the fuel injection quantity is corrected to be increased, and then corrected to be decreased after the engine is started. However, the present invention is different in that the fuel injection quantity is corrected to be increased when the engine is started, and is corrected to be only decreased after the engine is started.

In addition to a similar effect as that in claim 1, this configuration is effective in that the engine is reliably started, a time for starting the engine is shortened, rotation fluctuation of the engine is suppressed in a short time after the engine is started, etc.

This claims the benefit of Japanese Patent Application No. 2013-071512, filed on Mar. 29, 2013, in the Japanese Intellectual Property Office, the entire disclosure of which is incorporated herein.

To represent the present invention, the present invention has been appropriately and sufficiently described through the embodiments with reference to the drawings. However, it should be understood that those skilled in the art may easily change and/or improve the embodiments. Therefore, as long as a changed or improved embodiment implemented by those skilled in the art is within the scope of a claim described in Claims, the changed or improved embodiment is construed as being contained in the scope of the claim described in Claims.

### INDUSTRIAL APPLICABILITY

The present invention may suppress occurrences of engine stall and rotation fluctuation after an engine is started even when there is a gap between an estimated value of an alcohol concentration and an actual alcohol concentration in an internal combustion engine capable of using an alcohol-containing fuel, and thus contributes to development and improvement of a technology of an FFV in which a fuel in a fuel tank has a variously changing alcohol concentration.

1. A control device for an internal combustion engine capable of using an alcohol-containing fuel, comprising:
post-starting injection quantity increasing apparatus for performing a correction operation of increasing a fuel injection quantity from an initial fuel injection quantity after an engine is started to a fuel injection quantity set when, an alcohol concentration of a fuel is regarded as a maximum value or a value close to the maximum value within a predetermined range, when a variation of an engine speed is greater than or equal to a predetermined threshold during an idle operation until an oxygen concentration sensor provided to an exhaust passage is activated after the engine is started; and
post-starting injection quantity decreasing apparatus for performing a correction operation of repeatedly decreasing the increased fuel injection quantity by a smaller correction width than when performing the correction operation of increasing the fuel injection quantity until the variation of the engine speed becomes less than the threshold when the variation is greater than or equal to the threshold after the correction operation of increasing the fuel injection quantity by the post-starting injection quantity increasing apparatus.

2. The control device for an internal combustion engine according to claim 1, wherein the post-starting injection quantity increasing apparatus performs the correction operation of increasing the fuel injection quantity at one operation.

3. The control device for an internal combustion engine according to claim 1, wherein the post-starting injection quantity increasing apparatus divides the correction operation of increasing the fuel injection quantity into a plurality of operations and implements the operations one at a time.

4. The control device for an internal combustion engine according to claim 1, further comprising:
fuel injecting apparatus for injecting a fuel into a combustion chamber;
injection timing setting apparatus for setting fuel injection timing at which the fuel is injected by the fuel injecting apparatus to a second half of a compression stroke when the engine is started and, after the engine is started, advancing the fuel injection timing further than when the engine is started; and
ignition timing setting apparatus for setting ignition timing to a predetermined fixed value when the engine is started and variably controlling the ignition timing according to a water temperature and an external load after the engine is started.

5. The control device for an internal combustion engine according to claim 2, further comprising:
fuel injecting apparatus for injecting a fuel into a combustion chamber;
injection timing setting apparatus for setting fuel injection timing at which the fuel is injected by the fuel injecting apparatus to a second half of a compression stroke when the engine is started and, after the engine is started, advancing the fuel injection timing further than when the engine is started; and
ignition timing setting apparatus for setting ignition timing to a predetermined fixed value when the engine is started and variably controlling the ignition timing according to a water temperature and an external load after the engine is started.

6. The control device for an internal combustion engine according to claim 3, further comprising:
fuel injecting apparatus for injecting a fuel into a combustion chamber;
injection timing setting apparatus for setting fuel injection timing at which the fuel is injected by the fuel injecting apparatus to a second half of a compression stroke when the engine is started and, after the engine is started, advancing the fuel injection timing further than when the engine is started; and
ignition timing setting apparatus for setting ignition timing to a predetermined fixed value when the engine is started and variably controlling the ignition timing according to a water temperature and an external load.

7. A control device for an internal combustion engine capable of using an alcohol-containing fuel, comprising:
start-up injection quantity increasing apparatus for performing, when an engine is started, a correction operation of increasing a fuel injection quantity up to a fuel injection quantity set when, an alcohol concentration of a fuel is regarded as a maximum value or a value close to the maximum value within a predetermined range when an engine is not started by a predetermined number of times of ignitions; and
post-starting injection quantity decreasing apparatus for performing a correction operation of repeatedly decreasing the increased fuel injection quantity by a predetermined correction width until a variation of an engine speed becomes less than a predetermined threshold when the variation is greater than or equal to the threshold during an idle operation until an oxygen concentration sensor provided to an exhaust passage is activated after the engine is started.
